(19) United States
(12) Patent Application Publication
(10) Pub. No.: US 2006/0013404 A1
(43) Pub. Date: Jan. 19, 2006

(54) Stereo demodulator circuit

(76) Inventors: Tsuyoshi Koike, Aichi-ken (JP); Hiroshi Miyagi, Niigata-ken (JP)

Correspondence Address: MORGAN & FINNEGAN, L.L.P., 3 WORLD FINANCIAL CENTER, NEW YORK, NY, 10281-2101, US

(21) Appl. No.: 10/524,792

(22) PCT Filed: Aug. 21, 2003
(86) PCT No.: PCT/JP03/10584

§ 371 Date: Jul. 22, 2005

(30) Foreign Application Priority Data
Aug. 22, 2002 (JP) 2002-242105

(51) Int. Cl. H04H 5/00

(52) U.S. Cl. 381/13; 381/2

(57) ABSTRACT

A stereo demodulator circuit comprising at least one noise control unit for performing a noise control responding to an RSSI (reception electric-field intensity) when the RSSI is within a specified range, further comprises an AD converter unit for AD-converting a signal corresponding to the RSSI and a control signal producing unit for producing a control signal for a noise control performed in the noise control unit according to a noise level when the noise level obtained by the AD conversion is within the above described specified range. The control signal producing unit comprises an offset unit for digitally offsetting a signal obtained through the above described AD conversion by a predefined value and truncating lower bits off the offset value by the number of bits in compliance with a grade of the noise control accuracy and outputs the control signal based on the signal obtained from the offset unit.

### TECHNICAL FIELD

The present invention relates to a stereo demodulator circuit used for a stereo receiver, etc., particularly to an improvement of control technology applied to a series of circuits for a noise control equipped in the stereo demodulator circuit and further to the overall signal processing circuits including such a stereo demodulator circuit.

### BACKGROUND ART

A stereo demodulator circuit generally is a circuit generating the L and R signals based on a received RF (Radio Frequency) signal.

In such a stereo demodulator circuit, an IF (Intermediate Frequency) signal is gained by converting the frequency of a received RF signal in a frequency conversion circuit, the IF signal is amplified by a limiter/amplifier and further detected by an FM detection circuit, and thereby a composite signal is reproduced.

The reproduced composite signal, generally including a main component, L+R, and a side component, L−R, is diverged into two paths. That is, from the composite signal a component, L+R, is gained in one path while the other component, L−R, is obtained by mixing with a 38 kHz signal for example in the other path. From thus obtained components, i.e., L+R and L−R, the L signal and R signal are obtained by adding and subtracting, respectively, by using an adder/subtracter.

Additionally included sometimes is a noise control unit for attenuating signals and cutting high frequencies off signals in such a stereo demodulator circuit in order to suppress noise produced in the circuit itself and thereby improve a sound quality.

An example of the above is a high-cut control (hereinafter called “HCC”) performed in response to a reception electric-field intensity (hereinafter called “RSSI”) signal by equipping a HCC circuit configured for mixing the above described component, L+R, with a signal which high frequencies are cut off the component, L+R, in a mixing ratio responding to an RSSI signal which is a signal indicating the RSSI. Another example is a high-cut control in which a high frequency noise included in the L and R components in the above stereo-modulated signal is cut in a de-emphasis circuit.

Meanwhile, also known is a soft muting processing in which the above described composite signal is attenuated in a soft muting (hereinafter called “SMUTE”) circuit when the RSSI is small so that the effect of a mixed-in noise cannot be ignored.

Furthermore, also known is an adjustment of the mixing ratio of the main component, L+R, to the side component, L−R, blended by the adder/subtracter in order to suppress a cross-talk. That is, the side component, L−R, is attenuated by a stereo noise control (hereinafter called “SNC”) in an SNC circuit.

A relationship between the above described RSSI and a controlled variable in the respective circuit for performing the above described HCC, SMUTE and SNC processing is determined as exemplified by FIG. 1.

In FIG. 1, for example, the HCC processing is performed by the control signal C₂˜C₃ responding to the actual RSSI if the RSSI is within the range I₂˜I₃. Note that the control signal is kept at C₂ if the RSSI is smaller than the minimum value I₂ within the range, while the control signal is kept at C₃ if the RSSI is larger than the maximum value I₃ within the range.

Likewise, the SMUTE processing is performed by the control signal C₀˜C₁ responding to the actual RSSI if the RSSI is within I₀˜I₁; and the SNC processing is performed by the control signal C₄˜C₅ responding to the actual RSSI if the RSSI is within I₄˜I₅. The control signal is likewise kept at the constant values if the RSSI is outside of the respective range, the same as performing the HCC processing above.

In the above described stereo demodulator circuit, since each of the HCC, SNC and SMUTE processing is an analog control, there has been a problem of an accurate noise control being difficult due to an inherently unstable control operation.

Additionally, as the base voltage (i.e., bias voltage), i.e., the basis for generating a control signal determining a noise control variable in each of the HCC, SNC and SMUTE circuits, fluctuates caused by the ambient temperature changes or the processing variations, it has been difficult to continuously maintain the required bias voltage. In a conventional circuit (i.e., a differential amplifier circuit) applied with anon-zero bias, a predefined, non-zero bias (i.e., non-zero bias) is applied as the base voltage at the point, “a”, i.e., the input point for the base voltage, as exemplified by FIG. 2, and when the input value Vin which responds to the above described RSSI exceeds the above described base voltage (a predefined value), the difference of the two is amplified and outputted to each of the above described noise control circuits as the control signal.

Such configuration has been faced with problems such as the above described predefined bias value fluctuating caused by the temperature changes, processing variations, etc., resulting in a non-achievability of accurate noise control. In other words, a noise control processing by the above described HCC, SNC or SMUTE ends up with performing for the RSSI being out of the proper operating range, hence making a cause for the sound quality degradation.

### DISCLOSURE OF INVENTION

Consequently, the primary object of the present invention is to enable a stabilization of noise control performed by a noise control unit in a stereo demodulator circuit comprising at least one noise control unit for performing a noise control responding to a reception electric-field intensity when the reception electric-field intensity is within a specified range and contrive a simpler configuration of a control signal producing circuit for outputting a control signal for defining a control variable of the noise control.

The secondary object of the present invention is to make the above described noise control unit perform accurately, being unaffected by the temperature changes or variations of the processing.

In order to achieve the above described objects, the present invention comprises as follows.

First, a stereo demodulator circuit according to a first aspect of the present invention is a stereo demodulator circuit comprising at least one noise control unit for performing a noise control responding to a reception electric-field intensity when the reception electric-field intensity is within a specified range, and further comprising an AD converter unit for AD-converting a reception electric-field intensity signal indicating the reception electric-field intensity; an offset unit for digitally offsetting a digital signal obtained from the AD converter unit by a predefined value (e.g., a value according to the lowest value in the specified range) according to the specified range and truncating lower bits off the digital signal by the number of bits specified in compliance with a grade of noise control accuracy performed in the noise control unit; and a control signal output unit for outputting a control signal defining a control variable of a noise control performed in the noise control unit based on a signal obtained from the offset unit.

This configuration generates a control signal for defining a control variable for the noise control unit through a digital processing and thereby enables a significant stabilization of noise control operations as compared to a conventional method of generating a control signal through an analog processing.

Meanwhile, the offset unit is configured so as not only to digitally offset a digital signal obtained by an AD-conversion, but also to truncate lower bits off the digital signal by the number of bits in compliance with a grade of noise control accuracy performed in the noise control unit and generate a control signal in the control signal output unit based on the remaining bits. Therefore, a signal processing in the control signal output unit merely deals with a smaller number of bits in compliance with a grade of noise control accuracy as compared to a case of generating a control signal by using the number of bits of a signal obtained by an AD-conversion as is, thereby enabling an efficient signal processing. As a result, it is possible to configure a substantially simpler circuit constituting the control signal output unit. Note here that either the offsetting or the truncation of the lower bits can be processed first in the above contrivance.

Meanwhile, the noise control unit may be configured so as to be switched stepwise for providing a noise control variable responding to a control signal outputted from the control signal output unit. Such configurations, for example, include switching a plurality of switches responding to the above control signal and thereby increase or decrease the noise control variables stepwise.

Although the AD converter unit can actually be configured by a common AD conversion circuit, a configuration comprising a latch circuit for retaining a signal obtained by the AD conversion circuit is also in the scope of the present invention.

Second, a stereo demodulator circuit according to a second aspect of the present invention is a stereo demodulator circuit comprising at least one noise control unit for performing a prescribed control responding to a reception electric-field intensity when the reception electric-field intensity is within a specified range, and further comprising an offset unit for offsetting a reception electric-field intensity signal which is a signal indicating the reception electric-field intensity by a specified value (e.g., a value according to the lowest value in the specified range) according to the specified range; a difference output unit for comparing a signal obtained from the offset unit with a zero bias and outputting the resultant difference; and a control signal output unit for outputting a control signal defining a control variable of the control performed in the noise control unit based on a signal obtained from the difference output unit.

In such configuration, the offset unit actually offsets a reception electric-field intensity signal in advance, followed by the difference output unit comparing with the zero bias and outputting the resultant difference. Such configuration thus makes the basis for the comparison done in the difference output unit being the zero bias, and thereby enables an accurate noise control performed in the noise control unit being unaffected by the above described temperature changes, processing variations, etc.

Meanwhile, the present invention may be applied to a configuration having a plurality of noise control units in which case the specified range of reception electric-field intensity is respectively specified for each of the plurality of noise control units. The noise control units include, for example, a de-emphasis circuit, a soft muting circuit and a stereo noise control circuit.

The above described basic concept of the present invention can be applied not only to a stereo demodulator circuit but also to all signal processing circuits performing some kind of signal processing.

That is, a signal processing circuit according to a first aspect of the present invention is characterized by a signal processing circuit comprising at least one circuit part performing a prescribed control responding to an input signal level when the input signal level is within a specified range, and further comprising an AD converter unit for AD-converting a level signal which is a signal indicating the input signal level; an offset unit for digitally offsetting a digital signal obtained from the AD converter unit by a predefined value according to the specified range and truncating lower bits off the digital signal by the number of bits specified in compliance with a grade of the prescribed control accuracy performed in the circuit part; and a control signal output unit for outputting a control signal defining a control variable of the prescribed control performed in the circuit part based on a signal obtained from the offset unit.

Such a configuration of signal processing circuit enables a remarkable stabilization of control operations as with the above described stereo demodulator circuit according to the first aspect, and in addition, an efficient signal processing performed in the control signal output unit.

Meanwhile, a signal processing circuit according to a second aspect of the present invention is characterized by a signal processing circuit comprising at least one circuit part performing a prescribed control responding to an input signal level when the input signal level is within a specified range, and further comprising an offset unit for offsetting a level signal which is a signal indicating the input signal level by a predefined value according to the specified range; a difference output unit for comparing a signal obtained from the offset unit with a zero bias and outputting the resultant difference; and a control signal output unit for outputting a control signal defining a control variable of the prescribed control performed in the circuit part based on a signal obtained from the difference output unit.

Such a configuration of signal processing circuit enables an accurate control performed in the control circuit being unaffected by the temperature changes, processing variations, etc., as with the stereo demodulator circuit according to the second aspect described above.

### BRIEF DESCRIPTION OF DRAWINGS

FIG. 1 shows a range of the RSSI in which each of processing, the HCC, SMUTE and SNC is performed;

FIG. 2 illustrates a circuit of an example of a conventional circuit (a differential amplifier circuit) applied with a non-zero bias;

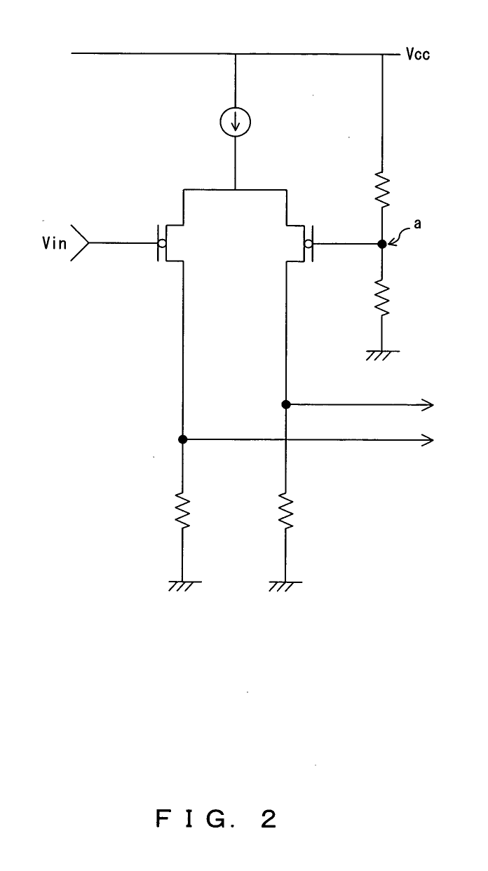

FIG. 3 shows a circuit of the stereo demodulator circuit 10 according to an embodiment of the present invention;

FIG. 4 shows a circuit of the control signal producing circuit 20 shown by FIG. 3;

FIG. 5 exemplifies an actual circuitry of the switch parts of the de-emphasis circuit 14 shown by FIG. 3; and

FIG. 6 shows a circuit of the differential amplifier circuit 30 adopted for a stereo demodulator circuit according to another embodiment of the present invention.

### BEST MODE FOR CARRYING OUT THE INVENTION

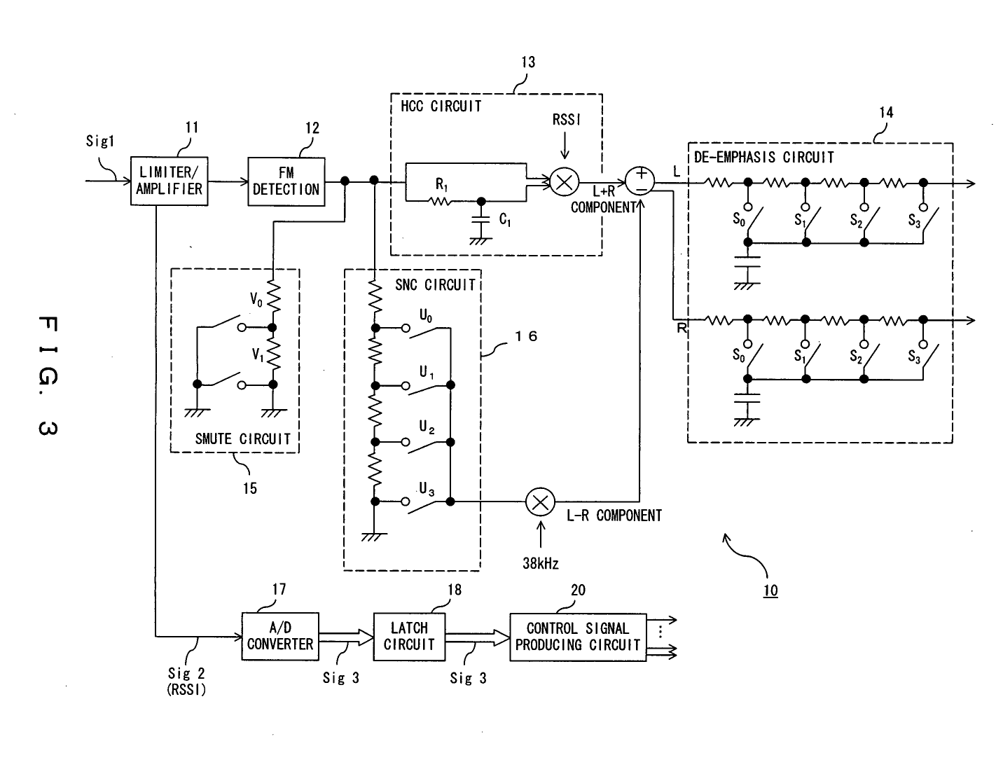

FIG. 3 shows a circuit of a stereo demodulator circuit 10 according to an embodiment of the present invention.

The stereo demodulator circuit 10 comprises, as a known configuration thereof, mainly a limiter/amplifier 11, an FM detection circuit 12, a high-cut control (“HCC” hereinafter) circuit 13, a de-emphasis circuit 14, a soft muting (“SMUTE” hereinafter) circuit 15, a stereo noise control (“SNC” hereinafter) circuit 16. In addition to the above described, the present embodiment further comprises an analog-to-digital (“A/D” hereinafter) converter 17, a latch circuit 18 and a control signal producing circuit 20. Note that the A/D converter 17 corresponds to the AD converter unit noted in the claims herein.

In the above configuration, an input signal (i.e., intermediate frequency signal) Sig1 is inputted to the FM detection circuit 12 by way of the limiter/amplifier 11, and a stereo composite signal is produced. Meanwhile, an RSSI signal Sig2 outputted from limiter/amplifier 11 is inputted to the A/D converter 17, as the AD converter unit, and thereby the analog RSSI signal Sig2 is converted to a digital signal Sig3. The analog-to-digital converted (“AD-converted” hereinafter) signal Sig3 is temporarily retained by the latch circuit 18 and then inputted to the control signal producing circuit 20.

In the control signal producing circuit 20, a control signal controlling each of a soft muting (SMUTE) processing by the SMUTE circuit 15, a stereo noise control (SNC) processing by the SNC circuit 16 and a high-cut control (HCC) processing by the de-emphasis circuit 14 are produced responding to the level of the inputted signal Sig3 (which corresponds to the RSSI).

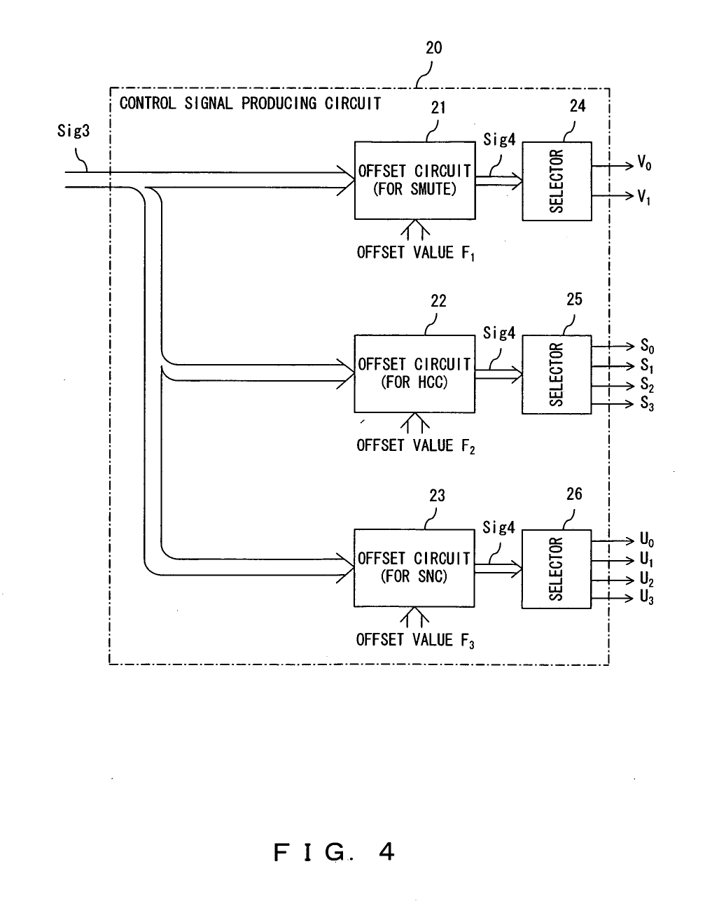

FIG. 4 shows a circuit of the control signal producing circuit 20.

The control signal producing circuit 20 comprises three offset circuits 21, 22 and 23, three selectors 24, 25 and 26 both disposed for the SMUTE, HCC and SNC processing, respectively, where the offset circuits 21, 22 and 23 correspond to the offset units noted in the claims herein, and the selectors 24, 25 and 26 correspond to the control signal output units noted in the claims herein.

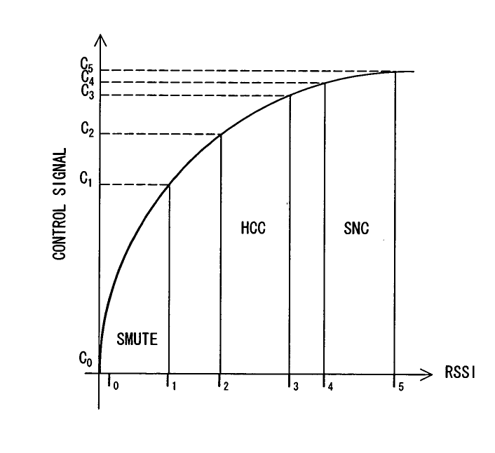

Here, the SMUTE circuit 15 performs the SMUTE processing responding to the actual RSSI if the RSSI is within the predefined range (i.e., I₀˜I₁ shown in FIG. 1), to the minimum value within the range (i.e., I₀ shown in FIG. 1) if the RSSI is smaller than the range, and to the maximum value within the range (i.e., I₁ shown in FIG. 1) if the RSSI is larger than the range. Consequently, a digital value corresponding to the minimum value (i.e., I₀ shown in FIG. 1) within the range of the above described RSSI considered by the SMUTE circuit is set as an offset value F₁ in the offset circuit 21 for such SMUTE circuit, and a digital signal Sig3 responding to the RSSI is digitally offset by the above described offset value F₁. Then, a number of lower bits, by the number of bits determined according to the grade of control accuracy required of the SMUTE circuit 15, are truncated from the signal obtained by the offset described above.

For example, let it be assumed that an actual original signal Sig3 is made up by 5 bits, and a considerably coarser control accuracy is enough for the SMUTE circuit 15. In such a case, the signal Sig3 is first offset by the offset value F₁ responding to the minimum value I₀ within the range of the RSSI considered in the SMUTE processing, and for example the lower two bits are truncated from the signal obtained by the offset, and then only the remaining upper three bits will be outputted. The signal made up by the upper three bits thus truncated by two bits will show a considerably coarser value than the actual RSSI value.

The offset circuit 22 disposed for the HCC and the offset circuit 23 disposed for the SNC are approximately the same as the offset circuit 21 disposed for the SMUTE. That is, they are configured as follows.

A digital value corresponding to the minimum RSSI value (i.e., I₂ shown in FIG. 1) within the range of the above described RSSI considered by the HCC processing in the de-emphasis circuit 14 is set as an offset value F₂ in the offset circuit 22 disposed for the HCC, and a digital signal Sig3 corresponding to the RSSI is digitally offset by the above described offset value F₂. Then, a number of lower bits, by the number of bits determined in compliance with a grade of control accuracy required of the de-emphasis circuit 14, are truncated from the signal obtained by the offsetting described above.

For example, let it be assumed that an actual original signal Sig3 is made up by 5 bits, and a little coarser control accuracy is enough for the de-emphasis circuit 14. In such a case, the signal Sig3 is first offset by the offset value F₂ corresponding to the minimum value I₂ within the range of the RSSI considered in the HCC processing, and for example the lowest one bit is truncated from the signal obtained by the offsetting, and then only the remaining upper four bits will be outputted. The signal made up by the upper four bits thus truncated by one bit will show a little coarser value than the actual RSSI value.

A digital value corresponding to the minimum value (i.e., I₄ shown in FIG. 1) within the range of the above described RSSI considered by the SNC circuit 16 is set as an offset value F₃ in the offset circuit 23 disposed for the SNC, and a digital signal Sig3 corresponding to the RSSI is digitally offset by the above described offset value F₃. Then, a number of lower bits, by the number of bits determined in compliance with a grade of control accuracy required of the SNC circuit 16, are truncated from the signal obtained by the offsetting described above (naturally, there is no need to truncate if no coarser control is preferred).

For example, let it be assumed that an actual original signal Sig3 is made up by 5 bits, and relatively fine control accuracy is required of the SNC circuit 16. In such a case, the signal Sig3 is first offset by the offset value F₃ corresponding to the minimum value I₄ within the range of the RSSI considered in the SNC processing, and no lower bit is truncated from the signal obtained by the offsetting, and then the original five bits will be outputted. The signal made up by the five bits without being truncated will show the same coarse value as the actual RSSI value.

As such, a signal made up by the number of bits in compliance with the respective control accuracy required for the SMUTE, HCC and SNC is outputted from each of the three offset circuits 21, 22 and 23, respectively, with the number of these bits being proportionate with the control accuracy. These offset circuits 21, 22 and 23 can actually be configured by the adders. That is, by retaining the negative value data respectively corresponding to each of the offset values F₁, F₂ and F₃, and by adding it to the signal Sig3 each offset value is actually subtracted from the signal, Sig3. On sending out the data thus obtained through the arithmetic operation, it is possible to truncate lower digits by devising so as not to send out those lower digits.

It goes without saying that other various methods are available for truncating these bits while arbitrarily setting the number of bits to be truncated. The truncation can also be done by cutting the number of bits off the signal Sig3 prior to the offsetting.

And now, each of the selectors 24, 25 and 26 is equipped in the subsequent stage of the offset circuits 21, 22 and 23, respectively, as shown by FIG. 4. These selectors 24, 25 and 26 are disposed for outputting control signals in order to control the respective noise control processing performed by the SMUTE circuit 15, de-emphasis circuit 14 and SNC circuit 16, all shown by FIG. 3, stepwise in response to the signal Sig4 (i.e., the signal obtained by the signal Sig3 offset and the lower bits truncated), outputted from each of the offset circuits 21, 22 and 23.

For instance, the SNC circuit 16 shown in FIG. 3 comprises a plurality of switches U₀, U₁, U₂ and U₃ disposed for changing resistance incrementally responding to an RSSI in order to perform the SNC processing responding to the RSSI, by selecting the switch U₀ for a reduced attenuation ratio of the L−R component, for example; or selecting U₁, U₂ or U₃, respectively and in this order, for an incrementally increased attenuation ratios. In this setup, the selector 26 disposed for the SNC outputs a control signal to the SNC circuit 16 instructing either one of the above described switches U₀, U₁, U₂ and U₃ is to be selected according to the signal Sig4 outputted from the offset circuit 23. There, although the signal Sig4 indicates a negative value if the RSSI is smaller than the predefined range (i.e., the range of I₄˜I₅ shown in FIG. 1), a control signal will be outputted instructing to select the switch U₀ corresponding to the lowest limit I₄, while a control signal will be outputted instructing to select the switch U₃ corresponding to the highest limit I₅, if the RSSI is larger than the predefined range (i.e., the range of I₄˜I₅ shown in FIG. 1).

Note that control signals for the HCC and SMUTE processing are respectively generated in the selector 25 disposed for the SNC and the selector 24 disposed for the SMUTE, as described thus far for the selector 26 disposed for the SNC.

For instance, in the case of the HCC processing performed in the de-emphasis circuit 14 (shown in FIG. 3), a control signal is outputted from the selector 25 according to the signal Sig4 outputted from the offset circuit 22 so as to select the switch S₀ for controlling to reduce the attenuation ratios of the L and R components, or one of the switches S₁, S₂ or S₃, respectively and in this order, for controlling to increase the attenuation ratios thereof. Also in this case, if the RSSI is out of the specified range (i.e., the range of I₂˜I₃ shown in FIG. 1), a control signal is outputted instructing to select a switch corresponding to either the lowest limit I₂ or the highest limit I₃, as with the selector 26 disposed for the SNC.

Likewise, in the case of the SMUTE processing performed in the SMUTE circuit 15 (shown in FIG. 3), a control signal is outputted from the selector 24 responding to the signal Sig4 outputted from the offset circuit 21 so as to select the switch V₀ for controlling to increase the attenuation ratio of the composite signal, or the switch V₁ for controlling to decrease the attenuation ratio thereof. Also in this case, if the RSSI is out of the specified range (i.e., the range of I₀˜I₁ shown in FIG. 1), a control signal is outputted instructing to select a switch corresponding to either the lowest limit I₀ or the highest limit I₁ as with the selector 26 disposed for the SNC.

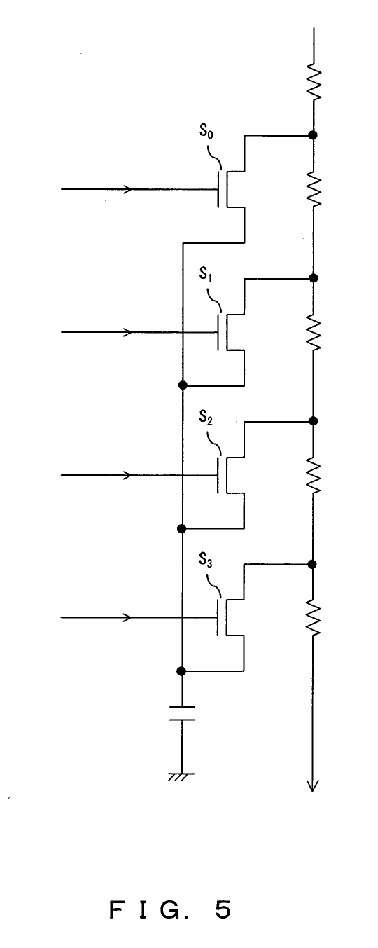

FIG. 5 exemplifies an actual circuitry of the switch parts of the de-emphasis circuit 14 shown by FIG. 3.

In FIG. 5, when the switch S₁ is selected, the signal outputted from the control signal producing circuit 20 indicates S₀=off, S₁=on, S₂=off and S₃=off. When another of these switches is selected, the signal is such that only the signal inputted to the selected switch is set for “on” and the others are set for “off.” Meanwhile, the similar switch parts for the SMUTE circuit 15 and the SNC circuit 16 can be configured in the same way as the switch part shown by FIG. 5 of the de-emphasis circuit 14 shown by FIG. 3.

According to the present embodiment thus far described, smaller numbers of digits are required for processing by the selectors 24, 25 and 26 as a result of truncating the number of lower bits in compliance with the required accuracy of each noise control and generating control signals based on the remaining upper bits in the selectors 24, 25 and 26, and hence an efficient signal processing is accomplished. Consequently, it is possible to configure the electors 24, 25 and 26 substantially simpler.

Note that, while the control signal producing circuit 20 is configured by hardware comprising the offset circuits and the selectors in the above described embodiment as shown in FIG. 4, a configuration thereof by a software operation is also possible. For example, the offset circuit 22 and the selector 25 disposed for the HCC exemplified above can be configured by software so that, first, a 4-bit signal is generated by truncating the lowest one bit from the 5-bit signal Sig3 in compliance with the required control accuracy of the HCC, and the offset value F₂ (e.g., 3-bit value) is subtracted from the aforementioned 4-bit signal. Then, if the subtraction result falls into a value corresponding to the range of the HCC, i.e., between I₂ and I₃ shown in FIG. 1 (e.g., the decimal 0 through 7), a control signal is outputted instructing to turn on one of the switches (i.e., switches S₀ through S₃ shown in FIG. 3) corresponding to the value, whereas if the above described subtraction result indicates a negative value, the same control signal as one corresponding to the result being “0” is outputted and if the above described subtraction result indicates an “8” or greater, then the same control signal as one corresponding to the result being “7” is outputted. The above is merely an example, and the control signals for the SMUTE and SNC can also be generated similarly according to those processing.

A stereo demodulator circuit according to the other embodiment of the present invention is then described as follows.

This embodiment premises a stereo demodulator circuit comprising at least one of the noise control units (e.g., the de-emphasis circuit 14, the SMUTE circuit 15 and the SNC circuit 16 as shown in FIG. 3) controlling a noise responding to an RSSI when the RSSI is within a specified range, and comprises a new control signal-producing circuit in place of the control signal producing circuit 20 equipped in the stereo demodulator circuit 10 shown in FIG. 3. Let it be assumed here that the control variable for a noise control in the above described noise control units is determined by an analog control signal and therefore the noise control units do not comprise a switch S, U or V as shown in FIG. 3.

Now, the above described unique control signal-producing circuit comprises a not-shown offset circuit digitally offsetting a signal Sig3 by a predefined value, i.e., the signal which has been A/D-converted by the A/D converter 17 as shown in FIG. 3 and temporarily retained by the latch circuit 18, a not-shown digital-to-analog (D/A) converter digital-to-analog (D/A)-converting the offset signal and the differential amplifier circuit 30 amplifying the difference between the D/A-converted signal and the zero bias, and outputting it as the above described control signal.

While each of the offset circuits 21, 22 and 23 can be adopted as the above described offset circuit, a function of truncating the lower bits is optional. The above described D/A converter can be adopted from the well known and therefore a description thereof is omitted herein.

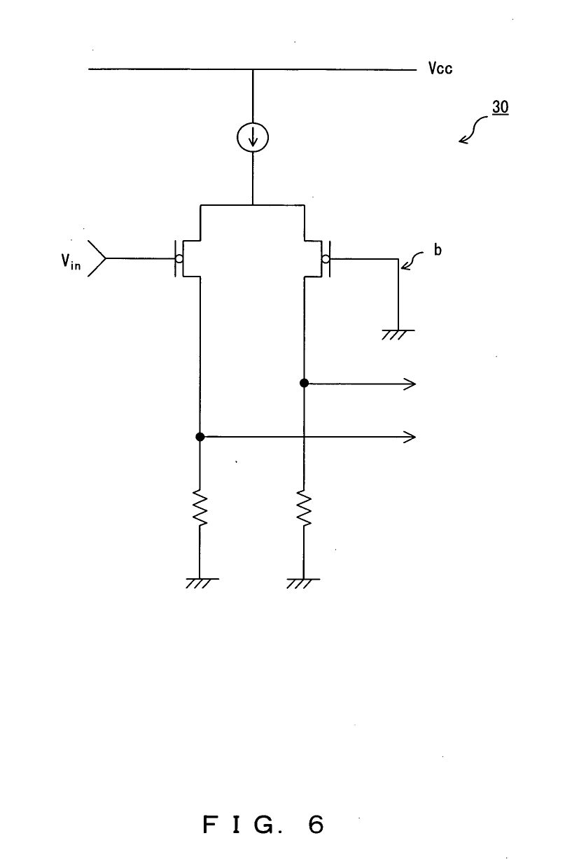

In the above described differential amplifier circuit 30, which is a differential amplifier circuit using a zero bias as the base voltage for comparison as made apparent by FIG. 6, an analog signal (i.e., a signal responding to an RSSI and already offset) obtained by D/A-conversion in the above described D/A converter is inputted to the Vin terminal, the analog signal is compared with the base voltage (i.e., zero volt) and an amplified difference between the above described two signals is outputted. That is, since the point “b” is at the grounded zero bias, the difference between the already offset input signal into the Vin terminal and the zero bias at the point “b” is amplified and outputted as a control signal to the above described noise control unit. In this case, the control signal is an analog signal, and hence the control variable for the above described noise control unit is continuously changed responding to the analog signal.

Such a configuration as above using the zero bias for the base voltage eliminates a fluctuation of the base voltage due to the temperature changes or processing variations, etc., thereby making the above described noise control unit perform a very precise noise control.

It shall be noted that the present invention is in no way limited to these configurations put forth by the above described embodiments but can be modified in various ways within the scope noted in each of the claims herein.

### APPLICABILITY TO USAGE IN INDUSTRIES

The technological concept of the present invention is applicable to not only a stereo demodulator circuit but also various signal processing circuits comprising at least one circuit part performing a prescribed control according to an input signal level if the level is within a predefined range.

1. A stereo demodulator circuit comprising at least one noise control unit for performing a noise control responding to a reception electric-field intensity when said reception electric-field intensity is within a specified range, further comprising:
an AD converter unit for AD-converting a reception electric-field intensity signal indicating said reception electric-field intensity;
an offset unit for digitally offsetting a digital signal obtained from said AD converter unit by a predefined value according to said specified range and truncating lower bits off said digital signal by the number of bits specified in compliance with a grade of noise control accuracy performed in said noise control unit; and
a control signal output unit for outputting a control signal defining a control variable of a noise control performed in said noise control unit based on a signal obtained from said offset unit.

2. The stereo demodulator circuit in claim 1, wherein said noise control unit is switched stepwise for providing a noise control variable responding to a control signal outputted from said control signal output unit.

3. A stereo demodulator circuit comprising at least one noise control unit for performing a noise control responding to a reception electric-field intensity when said reception electric-field intensity is within a specified range, further comprising:
an offset unit for offsetting a reception electric-field intensity signal indicating said reception electric-field intensity by a predefined value according to said specified range;
a difference output unit for comparing a signal obtained from said offset unit with a zero bias and outputting the resultant difference; and
a control signal output unit for outputting a control signal defining a noise control variable for said noise control unit based on a signal obtained from the difference output unit.

4. The stereo demodulator circuit in claim 1 further comprising a plurality of said noise control units, wherein said specified range is respectively specified for each of the plurality of noise control units.

5. A signal processing circuit comprising at least one circuit part performing a prescribed control responding to an input signal level when said input signal level is within a specified range, further comprising:
an AD converter unit for AD-converting a level signal which is a signal indicating said input signal level;
an offset unit for digitally offsetting a digital signal obtained from the AD converter unit by a predefined value according to said specified range and truncating lower bits off said digital signal by the number of bits specified in compliance with a grade of said prescribed control accuracy performed in said circuit part; and
a control signal output unit for outputting a control signal defining a control variable of said prescribed control performed in said circuit part based on a signal obtained from the offset unit.

6. A signal processing circuit comprising at least one circuit part performing a prescribed control responding to an input signal level when said input signal level is within a specified range, further comprising:
an offset unit for offsetting a level signal which is a signal indicating said input signal level by a predefined value according to said specified range;
a difference output unit for comparing a signal obtained from the offset unit with a zero bias and outputting the resultant difference; and
a control signal output unit for outputting a control signal defining a control variable of said control performed in said circuit part based on a signal obtained from the difference output unit.

7. The stereo demodulator circuit in claim 3 further comprising a plurality of said noise control units, wherein said specified range is respectively specified for each of the plurality of noise control units.
